(19) United States
(12) Patent Application Publication
(10) Pub. No.: US 2009/0248186 A1
(43) Pub. Date: Oct. 1, 2009

(54) Methods and Systems for Matching Configurable Manufacturing Capacity Requirements and Availability

(76) Inventor: Daniel Thomas Hamling, San Diego, CA (US)

Correspondence Address: Dan Hamling, 5461 Valerio Trail, San Diego, CA, 92130, US

(21) Appl. No.: 12/413,524

(22) Filed: Mar. 28, 2009

Related U.S. Application Data
(60) Provisional application No. 61/041,192, filed on Mar. 31, 2008.

(51) Int. Cl. G06F 19/00

(52) U.S. Cl. 700/99

(57) ABSTRACT

The present invention comprises methods and systems that provide the ability to functionally and temporally match configurable manufacturing capacity requirements and availability at their lowest levels of configurability. This is generally accomplished by first modeling the capabilities of the equipment comprising the required capacity and available capacity at their lowest allowed levels of configurability. Each of the required capabilities is then matched in turn against the corresponding available capabilities, generating a match ranking based on capability alignment and substitutability, as well as business objectives. In addition, the present invention identifies needed or excess capacity components for a given match—again described at the lowest allowed level of configurability. Furthermore, the present invention also iteratively matches capacity according to varying combinations of specified search attributes and terms to provide a sortable list of match results.

### FIELD OF INVENTION

The invention is related to methods and systems for managing manufacturing capacity, and more particularly to methods and systems that provide the ability to functionally and temporally match configurable manufacturing capacity requirements and availability at their lowest levels of configurability.

### BACKGROUND OF INVENTION

The complexities and uncertainties associated with the manufacturing of semiconductor products (“chips”) requires that some level of testing be performed on each chip before being shipped to customers. The extent of testing can range from sample testing for chips deploying straightforward designs and mature manufacturing processes, to several stages of lengthy, fully-functional, multi-temperature testing for chips using the latest technologies.

The automatic test equipment (ATE) used to perform the tests on semiconductor chips provide the stimulus to the chip, as well as capture and process the response from the chip, all under computer control. Since ATE must be able to source and capture many channels of the latest high-speed, smart-power, and high-precision signals, the ATE business model requires significant investments in research and development, applications engineering, and other support functions. The current industry average selling price for ATE is therefore in the range of $US0.5 million to $US1.5 million.

In order to manage the overall cost of test, ATE will typically be configured to have only the channels and capability needed to test a particular chip, making the manufacturing capacity provided by the ATE dedicated to a given chip, or at best, a chip family. Each ATE supplier, too, has a different architecture and set of channel attributes, adding another dimension of complexity and incompatibility to the test capacity. In addition, each chip has a unique list of required tests, making the cycle time through the test process chip-dependent. Furthermore, each chip requires a specific combination of peripheral components and equipment (e.g. interface fixtures and sockets, handling equipment and kits, etc.) that together with the ATE complete a full “test cell” of capacity. The many cells of semiconductor test capacity required today are therefore very diverse and non-uniform.

This variability makes it difficult for test providers to optimize the utilization of costly test assets and thus maximize their return on investment (ROI)—reducing the economic profits of not only the test provider, but also that of the test specifier and test equipment supplier. This issue is even more of a problem for the test subcontractor, whose founding business model relies on the efficient aggregation of test demand across a diverse set of test specifiers and their chips. The typically-cited one-third of test capacity that is unutilized accounts for an estimated US$1.8 billion of annual depreciation costs, a significant economic burden on the entire semiconductor test value chain.

The landscape of solutions related to semiconductor test generally addresses both low and high levels of operations abstraction, but leaves a conspicuous gap at the test capacity planning level. At the low level, the solutions ignore the chip's test capacity requirements and therefore cannot perform any of the test capacity planning functions needed to significantly improve ROI. Just above the low end are tools focused on overall equipment efficiency (OEE) which lack the demand aggregation and configuration management capabilities required of a value-adding test capacity planning solution. At the high level, well-known supply chain management, demand management, and business intelligence offerings treat test capacity simply as a “black box,” precluding any useful planning functionality that accounts for the non-uniformity of test capacity. At the test capacity management level are numerous, incompatible, obvious and rudimentary spreadsheet solutions that severely lack the detailed modeling sophistication and resulting precision and accuracy that are needed today.

A vital element that is missing from the prior art is an ability to perform the complex matching of test capacity requirements and availability at the lowest level of equipment configurability. Most current solutions perform this matching at a very high level, demanding many inefficient and expensive iterations to fully confirm the “match” at the level of detail necessary to ensure chip testability. This type of detailed matching is required throughout the test capacity specification, planning, and trading processes.

Thus, a solution is needed that enables sophisticated matching of configurable manufacturing capacity, like that which is used for testing of semiconductor chips.

### SUMMARY OF INVENTION

The present invention delivers the ability to match configurable manufacturing capacity requirements and availability.

In particular, the present invention comprises methods and systems that provide the ability to functionally and temporally match configurable manufacturing capacity requirements and availability at their lowest levels of configurability. This is generally accomplished by first modeling the capabilities of the equipment comprising the required capacity and available capacity at their lowest allowed levels of configurability. Each of the required capabilities is then matched in turn against the corresponding available capabilities, generating a match ranking based on capability alignment and substitutability, as well as business objectives. In addition, the present invention identifies needed or excess capacity components for a given match—again described at the lowest allowed level of configurability. Furthermore, the present invention also iteratively matches capacity according to varying combinations of specified search attributes and terms to provide a sortable list of match results.

### BRIEF DESCRIPTION OF DRAWINGS OF INVENTION

The accompanying drawings, which are incorporated in, and constitute a part of, this specification illustrate an embodiment of the invention and, together with the description, serve to explain the advantages and principles of the invention. In the drawings,

FIG. 1 illustrates a block diagram of the operating environment of the present invention;

FIG. 2 illustrates a block diagram of the server of the present invention;

FIG. 3 illustrates the main agents of the present invention;

FIG. 4-5 illustrates the methods of the agents of the present invention.

### DETAILED DESCRIPTION OF PREFERRED EMBODIMENT OF INVENTION

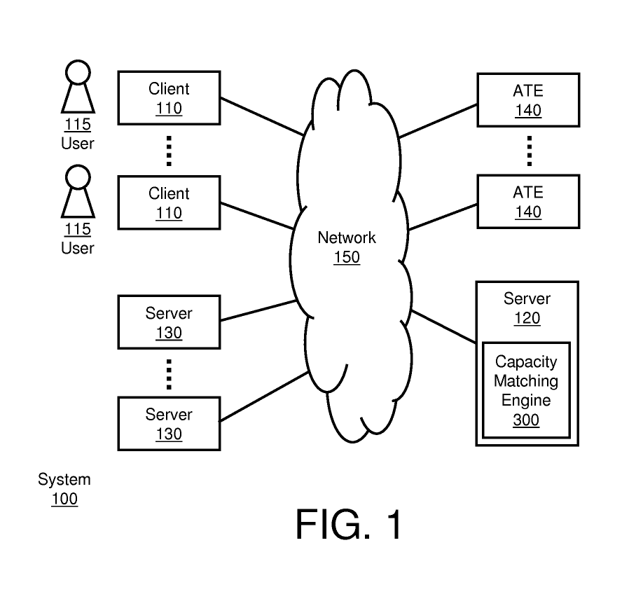

FIGS. 1 to 5 represent various aspects of the preferred embodiment of methods and systems that provide the ability to functionally and temporally match configurable manufacturing capacity requirements and availability at their lowest levels of configurability.

### System Architecture

FIG. 1 illustrates a system 100 in which methods consistent with the present invention may be implemented. System 100 includes multiple client devices 110, multiple servers 120 and 130, and multiple automatic test equipment (ATE) systems 140, all connected via a network 150. Network 150 shown comprises the Internet, but may also comprise other networks, such as an intranet or direct connections. Two client devices 110, one server 120, two servers 130, and two ATE systems 140 are shown as connected to network 150 for simplicity. Alternative embodiments may have different quantities of devices, servers, and systems than that shown. Also, client device 110 may perform the functions of server 120 or 130, and server 120 or 130 may perform the functions of client device 110. Moreover, methods according to the present invention may even operate within a single client device 110, server 120 or 130, or ATE system 140.

Through client devices 110, users 115 can communicate over network 150 with each other and with other devices and systems coupled to network 150. Examples of client devices 110 include mainframes, minicomputers, personal computers, laptops, digital assistants, personal digital assistants, cellular phones, mobile phones, smart phones, pagers, digital tablets, laptop computers, Internet appliances, or the like, capable of connecting to network 150. Client devices 110 transmit data over network 150 or receive data from network 150 via a wired, wireless, or optical connection.

Servers 120 and 130 include one or more types of computer systems, such as a mainframe, minicomputer, or personal computer, capable of communicating over network 150 with each other and with other devices and systems coupled to network 150. In other embodiments, servers 120 and 130 may include mechanisms for directly connecting to one or more client devices 110 or ATE systems 140. Servers 120 and 130 may also comprise multiple and/or distributed devices. Servers 120 and 130 transmit data over network 150 or receive data from the network 150 via a wired, wireless, or optical connection.

ATE systems 140 include one or more types of computer systems, such as a mainframe, minicomputer, or personal computer, capable of controlling the ATE operation and communicating over network 150 with each other and with other devices and systems coupled to network 150. ATE systems 140 transmit data over network 150 or receive data from the network 150 via a wired, wireless, or optical connection.

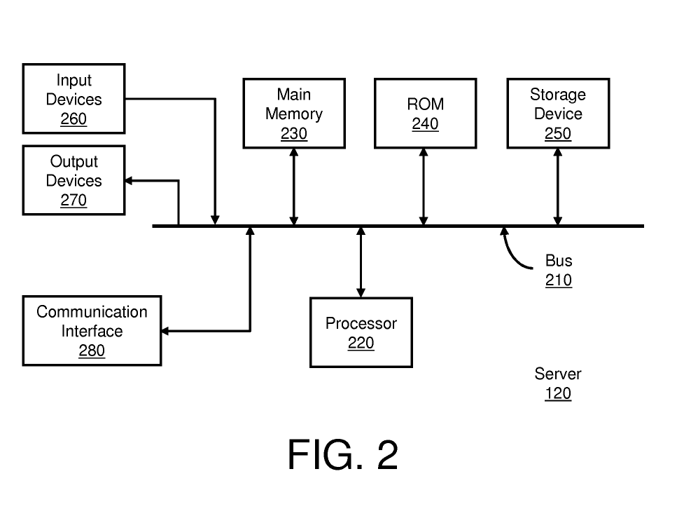

FIG. 2 illustrates the block diagram of server 120 consistent with the present invention. Server 120 includes a bus 210, a processor 220, a main memory 230, a read only memory (ROM) 240, a storage device 250, an input device 260, an output device 270, and a communication interface 280.

Bus 210 includes one or more conventional buses that permit communication among the components of server 120. Processor 220 includes any type of conventional processor or microprocessor that interprets and executes instructions. Main memory 230 includes a random access memory (RAM) or another type of dynamic storage device that stores information and instructions for execution by processor 220. ROM 240 includes a conventional ROM device or another type of static storage device that stores static information and instructions for use by processor 220. Storage device 250 includes a magnetic and/or optical recording medium and its corresponding drive.

Input device 260 includes one or more conventional mechanisms that permit information to be delivered to server 120, such as a keyboard, a mouse, a pen, voice recognition and/or biometric mechanisms, and the like. Output device 270 includes one or more conventional mechanisms that output information, such as a display, a printer, a speaker, and the like. Communication interface 280 includes any transceiver-like mechanism that enables server 120 to communicate with other devices and/or systems, directly and/or via a network, such as network 150.

As will be described in detail below, server 120, consistent with the present invention, performs certain capacity matching operations via the capacity matching engine 300. Server 120 performs these operations in response to processor 220 executing software instructions contained in a computer-readable medium, such as main memory 230. A computer-readable medium may be defined as one or more memory devices and/or carrier waves. The software instructions are read into main memory 230 from another computer-readable medium, such as data storage device 250, or from another device via communication interface 280. The software instructions contained in main memory 230 causes processor 220 to perform capacity matching operations described below. Alternatively, hardwired circuitry may be used in place of or in combination with software instructions to implement processes consistent with the present invention. Thus, the present invention is not limited to any specific combination of hardware circuitry and software.

Client devices 110, servers 130, and ATE systems 140 have computing architectures similar to that described above in reference to FIG. 2 for server 120. In the preferred embodiment, access to data stored on servers 130 and ATE systems 140 are most vital to implementing the methods of the present invention. For example, storage device 250 of servers 130 may contain enterprise planning, business intelligence, and chip test requirements data accessible by client devices 110 and server 120 for use in the preferred embodiment of the present invention. Similarly, storage device 250 of ATE systems 140 may contain equipment configuration, operational status, and chip test requirements data accessible by client devices 110 and server 120 for use in the preferred embodiment of the present invention.

### Agents and Methods

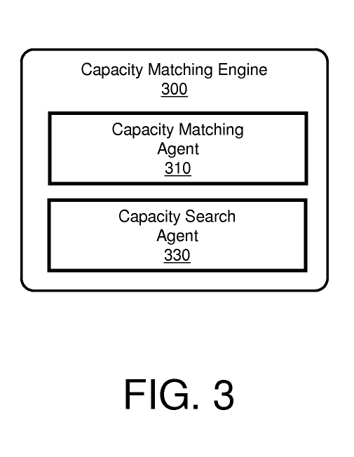

FIG. 3 illustrates capacity matching engine 300 comprised of software instructions that are collectively grouped into agents. Other software instruction groupings include services, applications, programs, procedures, classes, objects, subroutines, functions, web pages, scripts, queries, and the like. The agents shown include a capacity matching agent 310, and a capacity search agent 330. Capacity matching engine 300 performs capacity matching operations generally initiated by users 115 through client devices 110. Some operations may also be performed automatically on server 120 without any intervention by users 115. Such automatic operations will typically include the transmittal and retrieval of data from storage devices 250 of both servers 130 and ATE systems 140 over network 150. Data stored and used by engine 300 will typically be stored in a structured database format on storage device 250 of server 120.

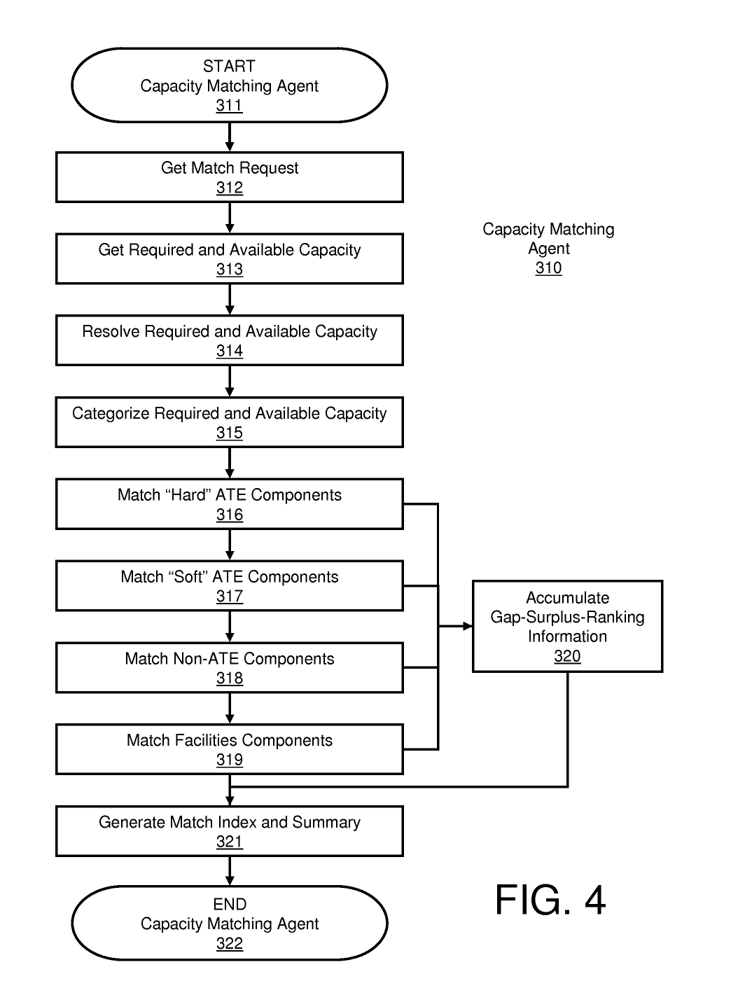

FIG. 4 illustrates the method of capacity matching agent 310, which performs the detailed matching of required test capacity and available test capacity, either existing or planned. The first step in agent 310 is to get match request 312. This is done via user 115 input at client device 110 or the passing of parameters and data from a calling procedure or agent. The parameters captured in step 312 will typically set the scope or context of the match to be performed. The request information from step 312 will be used by agent 310 to get required and available capacity 313 by creating a dataset, from data stored on storage device 250 of server 120, that describes the required and available capacity to be matched. The capacity data includes not only functional and temporal configuration attributes of the ATE but also functional and temporal attributes of related test cell equipment and consumables—such as material handlers, probers, and device interface boards—as well as other functional and temporal attributes such as those describing the disposition and state of the available test capacity. Agent 310 may also directly query each ATE system 140 according to the scope of match request 312 for its most current configuration. Available capacity will include planned capacity typically derived from enterprise planning system data, stored on storage device 250 of server 120, that describes recently purchased test capacity components that have yet to be installed or other test capacity component inventory. Agent 310 may therefore interface with the enterprise planning systems on various servers 120 owned by test equipment and consumables suppliers to collect delivery information and other information. Agent 310 will then resolve required and available test capacity 314 by breaking down the capacity dataset according to various rules and the lowest levels of configurability for each capacity component. The resolution is generally at the level of independently transferable components. For ATE systems 140, for example, this could be at the resolution of an instrument, channel, or channel attribute (e.g. speed license). The resolution can also depend on operational constraints related to configuration frequency, geographical mobility, resource availability, and the like. Finally, agent 310 will categorize required and available capacity 315 by grouping the resolved capacity datasets to prepare them for matching steps 316-319. The categories produced by step 315 will typically include “hard” ATE components, “soft” ATE components, non-ATE components, facilities components, and/or other attributes.

Agent 310 uses the resolved and categorized datasets describing the required and available capacity to first match the “hard” ATE components 316. The “hard” ATE components—such as ATE model, physical channel type and count, and the like—are matched first since these components typically have no or low substitutability, high cost, and long procurement lead times. Under certain usages of agent 310, an end to the attempted match may be desired if there is a misalignment in a particular “hard” component. Agent 310 will next match “soft” ATE components—including data rate licenses, memory depth licenses, software versions, and the like. The “soft” components are deemed necessary but expected to be more easily transferred and procured. Agent 310 will then match non-ATE components 318 and facilities components 319. Non-ATE components include material handler model, interface hardware, and the like. Facilities components include capacity owner, capacity location, capacity specifier and the like. The key facilities attributes will often be specified in the match request information from step 312 since these components have the most substitutability and are therefore most appropriate in setting scope or context. This is also why match facilities components 319 is the last match step. For all match steps 316-319, both a functional and temporal match is performed.

Following each match step 316-319, agent 310 will accumulate gap-surplus-ranking information 320. This information essentially describes the “closeness” of the match by specifying missing capacity components, extra capacity components—each to the lowest allowed levels of capacity configurability—and a match ranking based on criteria such as match request attributes, component cost, component lead times, component substitutability, and the like. The gap-surplus-ranking information is accumulated by step 320 throughout the four matching steps 316-319, and is weighted by the relative substitutability and accessibility of the components being matched at each level. As a final step, agent 310 will generate match index and summary 319. In this step a dataset is constructed summarizing the match request, the gap-surplus-ranking information, and other key information. Step 319 also creates an index for the match results for future reference in related match operations such as searches, displays, communications, browsing, and the like.

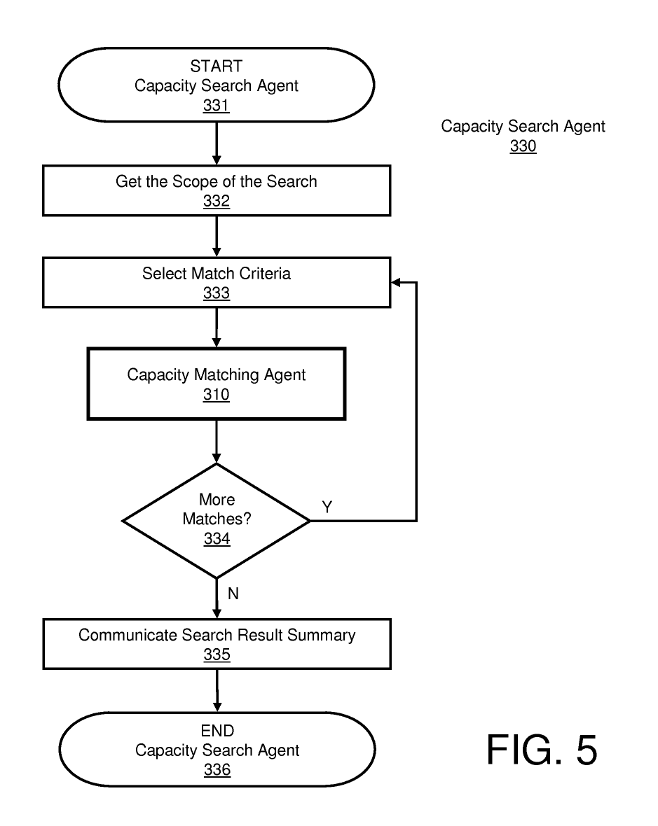

FIG. 5 illustrates the method of the capacity search agent 330, which iteratively matches required and available test capacity according to varying combinations of specified scope search terms to provide a sortable list of match results. The first step in agent 330 is to get the scope of the search 332. This is done via user 115 input at client device 110 or the passing of parameters from a calling procedure or agent. The search scope is defined by a set of search terms associated with relevant capacity attributes such as location, provider name, ATE type, and the like. The attributes are typically variable and selectable from a pre-defined list of those capacity attributes most useful for performing searches. User 115 will select each desired attribute and enter its associated search term. User 115 can also select the qualifier between the attribute and its search term, as well as the logical associations among the terms. Agent 330 will then select match criteria 333 from the search scope. The criteria will typically comprise a unique combination of the attributes and terms defined in step 332. If the search scope is narrowly defined, the match criteria may be the same as the search scope. In most cases, however, several sets of match criteria will be derived from the search scope. Step 333 may also use simple logic to generate explicit criteria from implicit scope terms—for example, entering the term “Taiwan” for the location attribute may generate a set of possible criteria that include all qualified test providers located in Taiwan.

Agent 330 then calls capacity matching agent 310 to perform the detailed matching of required test capacity and available test capacity, either existing or planned, according to the match criteria from step 333. As described above, agent 310 generates a match index and summary comprising a dataset summarizing the match request, the gap-surplus-ranking information, and other key information, as well as an index for the match results for reference. Following agent 310, agent 330 checks to see if more matches 334 are to be performed. Check 334 basically decides if more useful and unique combinations of the search scope attributes and terms remain for further matching using agent 310. If more combinations remain, select match criteria 333 is repeated followed by a call to the capacity matching agent 310.

If no further unique match criteria can be selected from the search scope, agent 330 will communicate search result summary 335. In step 335, the match results are presented in order of relevance or closeness of match, as determined by step 320 of agent 310. The summary is typically presented in tabular form with column headers corresponding to the key attribute categories of the match results. When seeking test capacity inventory, for example, the headers may be test provider, location, gap-surplus information, and the like. When seeking test capacity requirements, headers may be test specifier, device name, gap-surplus information, and the like. Each of these headers can be selected to sort the search result list in ascending or descending order of relevance. A title for each result will also be included in the summary, selectable to display detail on that specific result down to the lowest allowed levels of capacity configurability.

### General

While the description above of the present invention contains many specificities, these should not be construed as limitations on the scope of the invention, but rather as an exemplification of one preferred embodiment thereof. Accordingly, other modifications and variations may be possible in light of the above teachings. The embodiment above was chosen and described in order to best explain the principles of the invention and its practical application to thereby enable others skilled in the art to best utilize the invention in various embodiments and various modifications as are suited to the particular use contemplated. The appended claims and their legal equivalents are intended to determine the scope of the present invention which may include other alternative embodiments except insofar as limited by the prior art.

What is claimed is:

1. A method of defining a match between required and available configurable manufacturing resources, said method comprising the steps of: a) defining the scope of said match; b) defining the configuration attributes of each independent instance of said required resources; c) defining the configuration attributes of each independent instance of said available resources; c) performing a comparison of said configuration attributes; and d) defining the results of said match; where defining includes but is not limited to some combination of identifying, describing, calculating, communicating, and storing information.

2. The method of claim 1 wherein information describing said scope and said configuration attributes is acquired through a combination of user input and automatic retrieval from a plurality of data input and storage means.

3. The method of claim 1 wherein said configuration attributes include attributes that describe the lowest level of configurability of said resources.

4. The method of claim 1 wherein said configuration attributes include attributes that describe the operational support and performance of said resources, including but not limited to attributes describing peripheral equipment, software systems, and financial metrics.

5. The method of claim 1 wherein said configuration attributes include attributes that are time-dependent, including but not limited to attributes describing time-dependent configuration or location changes.

6. The method of claim 1 wherein said comparison further comprises the step of resolving said configuration attributes, whereby all transferable configuration components of said resources are identified and categorized.

7. The method of claim 1 wherein said results of said match comprise a summary description of said each independent instance of available resources with a link to the full details of said instance.

8. The method of claim 1 wherein said results of said match comprise a summary description of a logical group of said each independent instance of available resources with a link to the full details of said group and each underlying said instance.

9. The method of claim 1 wherein said comparison further comprises the step of assigning a match relevance rating to said each independent instance of said available resources, wherein said rating is calculated from algorithms constrained by a plurality of weighting factors, including but not limited to factors related to resource location, resource owner, configuration component gaps, and configuration component substitutability.

10. The method of claim 9 wherein said results of said match are listed in order of said match relevance rating, wherein said results are further sortable (e.g. alphabetically) by selected configuration attributes.

11. A method of performing a search of available configurable manufacturing resources for a match with required configurable manufacturing resources, said method comprising the steps of: a) defining the scope of said search; b) iteratively defining a set of match criteria based on unique combinations of attributes of said scope; c) performing said match of said available resources and said required resources constrained by said match criteria, comprising i) defining the configuration attributes of each independent instance of said required resources, ii) defining the configuration attributes of each independent instance of said available resources, and iii) performing a comparison of said configuration attributes; and d) defining the results of said search when all said unique combinations have been exhausted; where defining includes but is not limited to some combination of identifying, describing, calculating, communicating, and storing information.

12. The method of claim 11 wherein information describing said scope and said configuration attributes is acquired through a combination of user input and automatic retrieval from a plurality of data input and storage means.

13. The method of claim 11 wherein said configuration attributes include attributes that describe the lowest level of configurability of said resources.

14. The method of claim 11 wherein said configuration attributes include attributes that describe the operational support and performance of said resources, including but not limited to attributes describing peripheral equipment, software systems, and financial metrics.

15. The method of claim 11 wherein said configuration attributes include attributes that are time-dependent, including but not limited to attributes describing time-dependent configuration or location changes.

16. The method of claim 11 wherein said constraining defines a subset of said available resources included in said comparison based on limited or no substitutability of said match criteria, including but not limited to criterion related to resource make and model, resource owner, and resource location.

17. The method of claim 11 wherein said comparison further comprises the step of resolving said configuration attributes, whereby all transferable configuration components of said resources are identified and categorized.

18. The method of claim 11 wherein said results of said match comprise a summary description of said each independent instance of available resources with a link to the full details of said instance.

19. The method of claim 11 wherein said results of said match comprise a summary description of a logical group of said each independent instance of available resources with a link to the full details of said group and each underlying said instance.

20. The method of claim 11 wherein said comparison further comprises the step of assigning a match relevance rating to said each independent instance of said available resources, wherein said rating is calculated from algorithms constrained by a plurality of weighting factors, including but not limited to factors related to resource owner, resource location, configuration component gaps, and configuration component substitutability.

21. The method of claim 20 wherein said results of said search comprise said each independent instance of available resources listed in order of said match relevance rating, wherein said results of said search are further sortable (e.g. alphabetically) by selected configuration attributes.
